(19) United States
(12) Patent Application Publication
(10) Pub. No.: US 2010/0185335 A1
(43) Pub. Date: Jul. 22, 2010

(54) WORK MACHINE CONTROL DEVICE

(76) Inventor: Ikuhisa Sawada, Tokyo (JP)

Correspondence Address: DARBY & DARBY P.C., P.O. BOX 770, Church Street Station, New York, NY, 10008-0770, US

(21) Appl. No.: 12/305,899

(22) PCT Filed: Feb. 29, 2008
(86) PCT No.: PCT/JP2008/053649

§ 371 Date: Dec. 19, 2008

(30) Foreign Application Priority Data
Apr. 19, 2007 (JP) 2007-110667

(51) Int. Cl. E02F 9/22; E02F 9/20; E02F 9/26; G05D 16/00; G05B 11/00

(52) U.S. Cl. 700/282; 701/50; 700/275

(57) ABSTRACT

An operation panel and a monitor for displaying the operating status of the work machine and other information. The operation panel has a switch for operating a quick coupler mounted on a work arm so that the quick coupler performs attaching and detaching operation. In conjunction with operation of the switch, the monitor is switched from a default screen displaying the operating status of the work machine to a screen for prompting selection of an attachment. Connected to the monitor is a controller, to which an attachment hydraulic circuit is connected. The controller serves to switch settings for the attachment hydraulic circuit in accordance with the hydraulic attachment that has been selected by using the monitor. The invention enables reliable switching of settings for the attachment fluid pressure circuit in accordance with the attachment mounted, without requiring each attachment to be provided with identification information.

### CROSS-REFERENCE TO PRIOR RELATED APPLICATIONS

This is a U.S. national phase application under 35 U.S.C. §371 of International Patent Application No. PCT/JP2008/053649 filed Feb. 29, 2008, and claims the benefit of Japanese Application No. 2007-110667, filed Apr. 19, 2007. The International Application was published in the Japanese language Nov. 6, 2008 as WO 2008/132874 under PCT Article 21(2) and the contents of all the foregoing applications are incorporated herein in their entireties.

### TECHNICAL FIELD

The present invention relates to a control device for a work machine that is provided with an attachment attaching and detaching device.

### BACKGROUND

In case of a hydraulic excavator that is not provided with a detecting means for identifying an attachment attached thereto, the operator of the hydraulic excavator has to change various settings for the hydraulic system, such as pressure, flow rate, or degree of priority with respect to other actuators, whenever changing the attachment. Neglecting to carry out this procedure may cause hydraulic oil to flow in reverse or at a pressure or flow rate exceeding the maximum allowable pressure or flow rate of the attachment, presenting the possibility of damage to the attachment or shortening of the life span of the main body of the hydraulic excavator.

Setting of the hydraulic system has been simplified by a method that comprises steps of storing data necessary for various attachments that may replace a default attachment in a memory in the main body of the hydraulic excavator and selecting one of the attachments. However, as rented hydraulic excavators are being used more frequently, many operators are unfamiliar with setting procedures. The possibility also exists that the operator may make a mistake with the setting or forget to assign the setting altogether.

Examples of means provided to solve these problems include methods comprising steps of representing attachment identification data in the form of (1) an IC tag, (2) a bar code, or (3) a bit pattern set in a harness connector, attaching the IC tag, bar code, or harness connector to the main body of the respective attachment, and reading the data by means of an automatic identification device, such as (1) an antenna, (2) a bar code reader, or (3) a harness connector, mounted on or incorporated in the main body of the hydraulic excavator (e.g. See Japanese Patent No. 3323791 (page 5, and FIG. 1); Japanese Laid-open Patent Publication No. 11-140911 (page 6, and FIG. 1); and Japanese Patent No. 3210221 (page 3, and FIG. 1)).

However, these methods using an automatic identification device present problems described below.

None of these methods is able to provide sufficient reliability. For example, (1) an IC tag may produce a reading error due to noise or by the approach of another attachment; (1) an IC tag and (2) a bar code may interfere with reading function due to adherence of earth and sand thereto; and (3) a harness connector employing a bit pattern may interfere with reading function due to intrusion of earth and sand, or water.

Furthermore, (1), (2), and (3) all present a problem of being vulnerable to vibration during excavation, collision with earth or rock, as well as intrusion of water.

Furthermore, (3) the harness connector employing a bit pattern also presents a problem in that the troublesome task of connecting the harness connector is necessary.

Moreover, in addition to high production costs, (1), (2), and (3) all present a problem in that each attachment requires corresponding hardware to make identification. Therefore, when using an attachment that is not provided with hardware for identification, such as a rental attachment, the operator must make the necessary settings manually.

In order to solve the above problems, the present invention has been made and an object of the invention is to provide a work machine control device that enables reliable switching of settings for an attachment fluid pressure circuit in accordance with the attachment mounted, without requiring each attachment to be provided with identification information thereof.

### SUMMARY OF THE INVENTION

According to the present invention, a work machine control device includes a switch for operating an attachment attaching and detaching device that is mounted on a work arm and serves to attach or detach a fluid pressure operated attachment; a monitor for displaying a prompting screen for selecting an attachment in conjunction with operation of the switch for operating the attachment attaching and detaching device; and a controller for switching, in accordance with the attachment selected by using the monitor, settings for an attachment fluid pressure circuit that serves to operate the attachment.

According to the present invention, the controller of the work machine control device according to the above is capable of restraining functioning of the attachment fluid pressure circuit until selection of an attachment is made.

According to the present invention, the controller of the work machine control device is capable of causing a notification signal to be output to urge selection of an attachment until selection is made.

According to the present invention, a prompting screen for selecting an attachment is displayed by the monitor in conjunction with operation of the switch for operating the attachment attaching and detaching device, and the controller switches settings for the attachment fluid pressure circuit in accordance with the attachment selected by using the monitor. Therefore, the monitor facilitates operation for selecting an attachment, and it is also possible to prevent a lapse or an operation mistake even by an unaccomplished operator. The configuration as above enables reliable switching of settings for the attachment fluid pressure circuit in accordance with the attachment mounted, without requiring each attachment to be provided with identification information thereof.

According to the present invention, the controller restrains functioning of the attachment fluid pressure circuit until selection of an attachment is made. Therefore, even if the operator starts operation without remembering to perform selecting operation, not only is it possible to prevent damage to the attachment but also promptly alerts the operator to the irregularity, thereby reminding the operator to perform selection of an attachment.

According to the present invention, the controller causes a notification signal to be output to urge selection of an attachment until selection is made. Therefore, selection of an attachment is ensured.

### BRIEF DESCRIPTION OF THE DRAWINGS

FIG. 1 is a schematic view of a work machine control device according to an embodiment of the present invention.

FIG. 2 is a side view of the aforementioned work machine.

FIG. 3 is a perspective view of an attachment attaching and detaching device of the aforementioned work machine.

FIG. 4 is a perspective view showing the internal structure of the aforementioned attaching and detaching device.

FIG. 5 is a side view of the attaching and detaching device, illustrating the state immediately before engagement.

FIG. 6 is a side view of the attaching and detaching device, illustrating the state in which the attaching and detaching device is engaged at one end thereof.

FIG. 7 is a side view of the attaching and detaching device, illustrating the state in which the attaching and detaching device is engaged at both ends thereof.

FIG. 8 is a side view of the attaching and detaching device, illustrating how a bucket is moved after engagement of the attaching and detaching device.

FIG. 9 is a flow chart illustrating a procedure controlling the switching of a setting when replacing an attachment by using the attaching and detaching device.

### DETAILED DESCRIPTION OF THE INVENTION

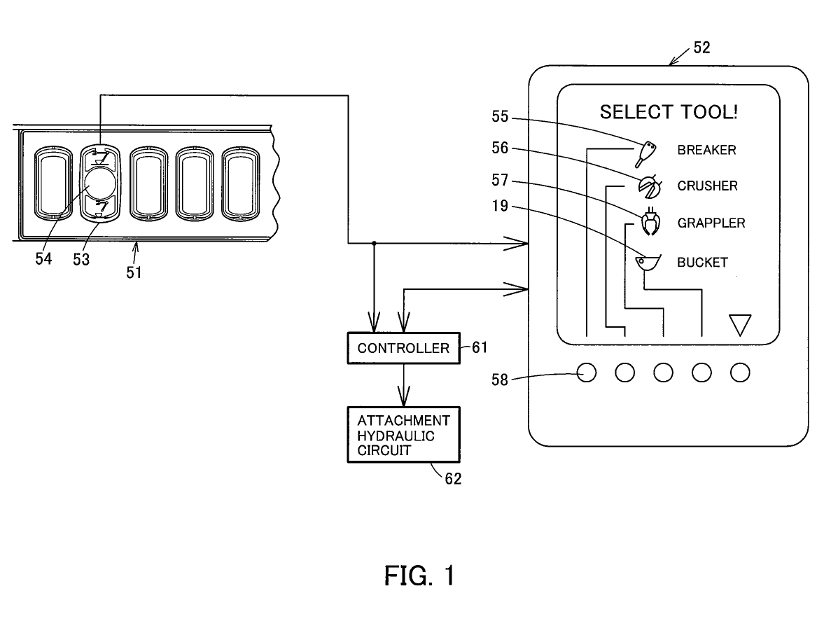

Next, the present invention is explained in detail hereunder, referring to an embodiment thereof shown in FIGS. 1 to 9.

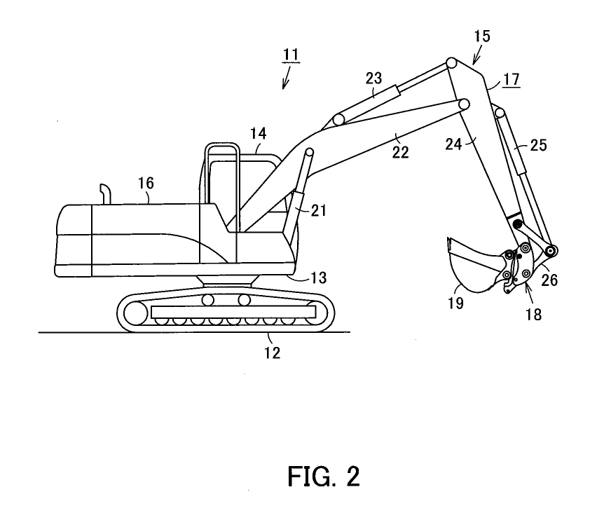

As illustrated in FIG. 2, a work machine 11 includes a lower structure 12, an upper structure 13, a cab 14 constituting an operator's cabin, a work equipment 15, and a power system 16 that includes an engine or the like, respectively. The cab 14, the work equipment 15, and the power system 16 are mounted on the upper structure 13, which is rotatably mounted on the lower structure 12. The engine drives hydraulic source pumps that serve as a fluid pressure source. The lower structure 12, the upper structure 13, and the work equipment 15 are adapted to be operated by hydraulic actuators, which are fluid pressure actuators adapted to be driven and controlled by a hydraulic circuit serving as a fluid pressure circuit.

The work equipment 15 comprises a work arm 17, a hydraulic quick coupler (hereinafter referred to as the quick coupler 18) serving as an attachment attaching and detaching device, and a bucket 19. The bucket 19 is an attachment, i.e. a work tool, and removably attached to the distal end of the work arm 17 via the quick coupler 18. The work arm 17 includes a boom 22 adapted to be pivoted by boom cylinders 21, and an arm 24 adapted to be pivoted by an arm cylinder 23. The arm 24 is attached to the distal end of the boom 22 by pin. The quick coupler 18 is attached to the distal end of the arm 24 and adapted to be pivoted by a bucket cylinder 25 and a link plate 26.

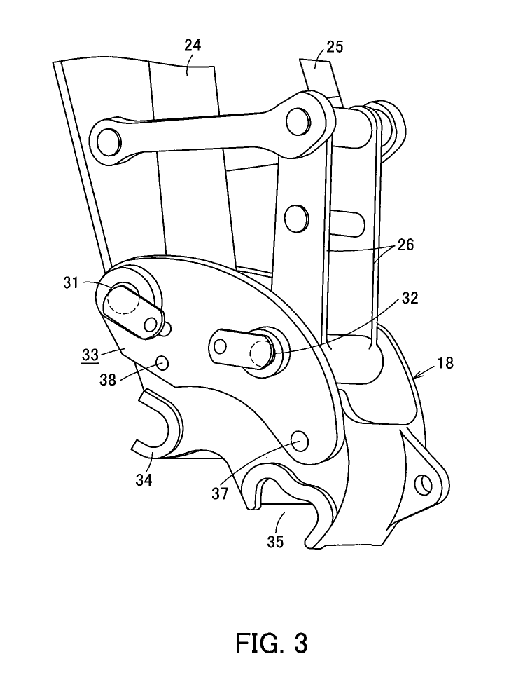

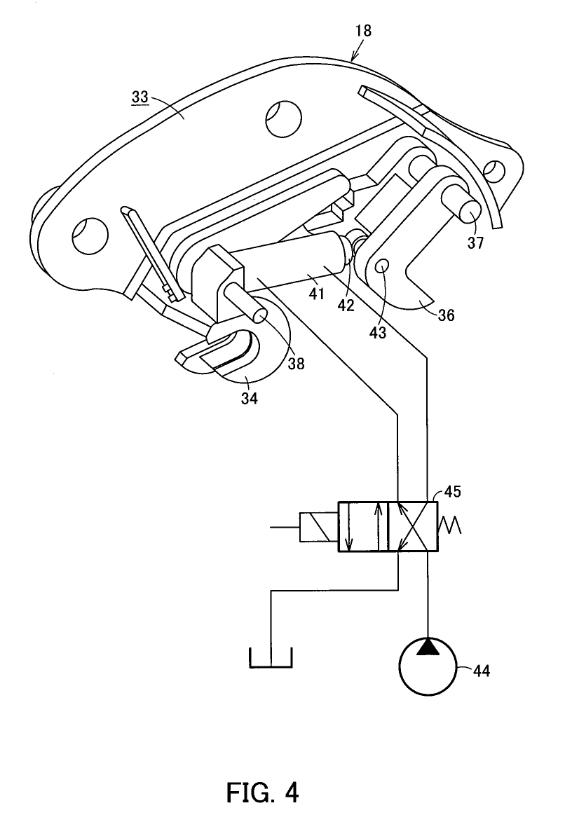

FIGS. 3 and 4 illustrate an example of the quick coupler 18, wherein the upper part of a coupler body 33 is rotatably coupled to the distal end of the arm 24 and the distal end of the link plate 26 by shafts 31,32, respectively. A fixed engaging portion 34 is formed at one end of the lower part of the coupler body 33 as an integral part thereof. Formed at the other end of the lower part of the coupler body 33 is a recess 35, in which a movable engaging portion 36 is disposed. As illustrated in FIG. 4, the distal end of the movable engaging portion 36 is capable of motion, and the base end of the movable engaging portion 36 is attached to the coupler body 33 by a shaft 37 so that the movable engaging portion 36 is capable of pivoting.

Disposed in the coupler body 33 is an attaching and detaching cylinder 41, which is pivotally supported at the base end by a shaft 38. The attaching and detaching cylinder 41 has a piston rod 42, which is pivotally coupled at the distal end to the middle part of the movable engaging portion 36 by a shaft 43. Through the directional control of hydraulic oil fed from hydraulic pumps 44, the attaching and detaching cylinder 41 is switched between a locked position illustrated in FIG. 4, at which the attaching and detaching cylinder 41 is in a non-excited state, and an unlocked position, at which the attaching and detaching cylinder 41 is in an excited state. The aforementioned directional control of the hydraulic oil is performed by means of a solenoid-operated directional control valve 45.

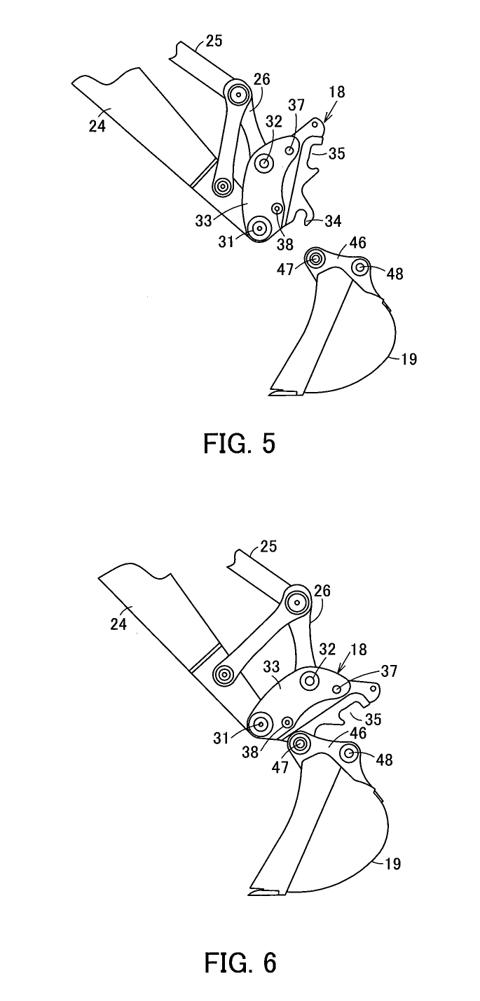

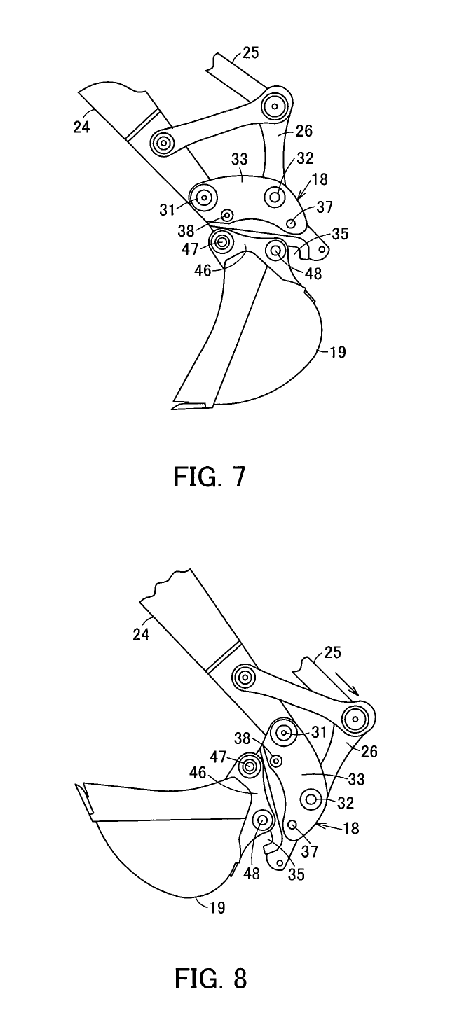

The bucket 19 has a bracket 46 provided with two pins 47,48. As illustrated in FIGS. 5 to 6, the fixed engaging portion 34 of the quick coupler 18 is adapted to catch one of the pins, i.e. the pin 47, from the inside part of the bracket 46. As illustrated in FIGS. 6 to 7, the coupler body 33 is then pivoted clockwise around the pin 47 so that the recess 35 is fitted over the pin 48. In the state where the coupler body 33 is in close contact with the bucket 19 as illustrated in FIG. 7, the solenoid-operated directional control valve 45 illustrated in FIG. 4 is switched to extend the piston rod 42 of the attaching and detaching cylinder 41 so that the movable engaging portion 36 is pivoted counterclockwise and catches the pin 48 from the inside part of the bracket 46. As a result, the quick coupler 18 and the bucket 19 integrally secured to each other by means of engagement of the fixed engaging portion 34 and the movable engaging portion 36 with the pair of pins 47,48. As illustrated in FIG. 8, extending the bucket cylinder 25 causes the bucket 19, which is integrally secured to the bucket cylinder 25 through the quick coupler 18, to move below the arm 24.

FIG. 1 illustrates an operation panel 51 and a monitor 52. The operation panel 51 is disposed near an operator's seat (not illustrated) provided in the cab 14. The monitor 52 normally displays on screen the operating status of the work machine, such as the volume of remaining fuel. The operation panel 51 is provided with a switch 53 for operating the quick coupler 18 mounted on the work arm 17 so that the quick coupler 18 performs attaching and detaching operation. The switch 53 has a lever 54 adapted to function in such a manner that pulling up the lever 54 and then pushing the lever 54 forward, in other words upward as viewed in FIG. 1, causes the solenoid-operated directional control valve 45 illustrated in FIG. 4 to be controlled to a locking position and that pulling up the lever 54 and then pulling back the lever 54, in other words downward as viewed in FIG. 1, causes the solenoid-operated directional control valve 45 to be controlled to an unlocking position.

In conjunction with switching operation of the quick coupler 18, the monitor 52 is switched from the default screen displaying the operating status of the work machine to a screen for prompting selection of an attachment. For example, the monitor 52 displays hydraulic attachments, such as a hydraulic operated breaker 55, a hydraulic operated crusher 56, and a hydraulic operated grappler 57, all of which are fluid pressure operated attachments, in addition to the bucket 19, which is not a fluid pressure operated actuator.

Selecting an attachment by the monitor 52 is done by means of a touch panel or button switches 58 assigned for respective attachments. The monitor 52 also has a function of a speaker for sounding an emergency alarm by buzzer or providing guidance by voice.

Although the monitor 52 illustrated in FIG. 1 has button switches 58, the manner of selecting an attachment is not limited to operation by such assigned buttons; for example, selection may be made by choosing a hydraulic attachment by means of a selection button unit comprising such as an “up” button and a “down” button, and executing the selection by means of an “enter” button.

A controller 61 is connected to the monitor 52. An attachment hydraulic circuit 62 that serves as an attachment fluid pressure circuit for operating the hydraulic attachment is connected to the controller 61.

The controller 61 has a memory device for storing data for changing set conditions of the attachment hydraulic circuit 62 in accordance with the hydraulic attachment that has been selected. As the memory device of the controller 61 includes a memory for storing which hydraulic attachment has been selected, there is no need to repeat the procedure for selecting the hydraulic attachment when restarting the work machine. It is desirable to use a nonvolatile memory as the memory for this purpose, because the nonvolatile memory is capable of retaining the stored information even when power is turned off, unless the stored information is cleared.

The controller 61 serves to switch settings for the attachment hydraulic circuit 62 in accordance with the hydraulic attachment that has been selected by using the monitor 52. Examples of settings to be switched include the pressure and flow rate of hydraulic oil to be fed to the hydraulic attachment, as well as the degree of priority with respect to the other actuators, such as the boom cylinders 21, the arm cylinder 23, etc.

Until selection of the attachment is completed, the controller 61 restrains the functioning of the attachment hydraulic circuit 62 while retaining the display for urging selection. The controller 61 also has a function of causing a notification signal to be output to urge selection of an attachment until selection is made.

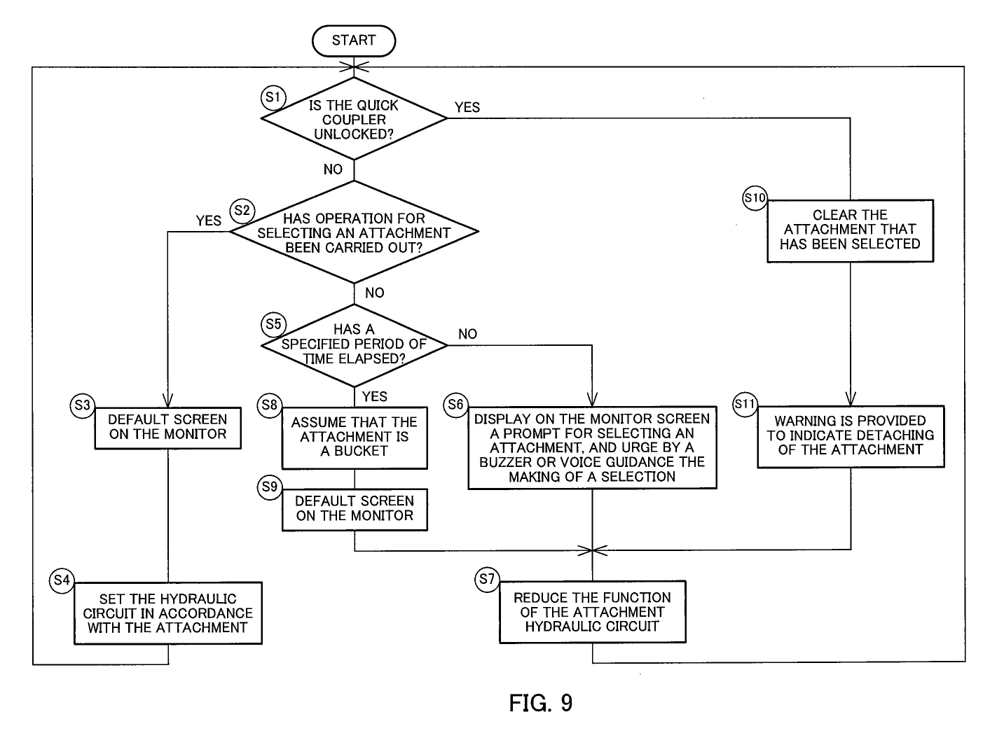

Next, control of the switching of settings by the controller 61 is explained hereunder, referring to the flow chart illustrated in FIG. 9.

(Step S1)

Whether or not the switch 53 for operating the quick coupler 18 to perform attaching and detaching operation is at the unlocking position is determined. The switch 53 is operated by tilting the lever 54 forward or backward after pulling up the lever 54. Therefore, even if the lever 54 is exposed to a force in such a direction as to tilt the lever 54 by an accidental contact or other unintentional force, such a force alone does not shift the switch 53 to the unlocking position.

(Step S2)

If the switch 53 is not at the unlocking position, it means that an attachment is already attached so that the lever 54 has returned to its default position. Therefore, whether or not operation for selecting an attachment has been carried out is determined. At that time, the screen of the monitor 52 is automatically switched to the attachment display screen illustrated in FIG. 1, in other words to a screen for prompting the operator to select an attachment, in other words designate the attachment mounted, from among a plurality of available attachments, such as, for example, the hydraulic operated breaker 55, the hydraulic operated crusher 56, the hydraulic operated grappler 57, and the bucket 19.

As selecting an attachment can be performed by means of such a component of the monitor 52 as a touch panel, the button switches 58 assigned for respective attachments, or the aforementioned combination of the selection button unit and the “enter” button, whether or not an attachment has been selected can be determined.

(Step S3)

If an attachment has been selected, the display on the monitor 52 is switched back to the default screen, such as display of the volume of remaining fuel.

(Step S4)

In accordance with the attachment that has been selected, hydraulic settings for the attachment hydraulic circuit 62 are automatically switched. For example, the pressure and flow rate of hydraulic oil to be fed to the hydraulic attachment, as well as the degree of priority with respect to the other actuators, are automatically adjusted.

(Step S5)

If it is determined in Step S2 that no attachment has been selected, whether or not a specified period of time has elapsed is determined.

(Step S6)

Should the state continue in which selection of an attachment is not made, until it is determined in Step S5 that the specified period of time has elapsed, a notification signal in the form of a buzzer or voice guidance is output to urge the making of a selection, while the monitor continues to display the prompt for selecting an attachment.

(Step S7)

Throughout the aforementioned period of time, the function of the attachment hydraulic circuit 62 is reduced by withholding the supply of hydraulic oil to the hydraulic attachment, or limiting the pressure or flow rate of the supplied hydraulic oil to an extremely low level. As a result, when the operator tries to operate the attachment, damage to the hydraulic attachment is prevented, and the operator is readily reminded of the fact that attachment selection has been forgotten. This reduction of the function of the attachment hydraulic circuit 62 is performed through automatic control, such as, for example, reducing the set pressure of the relief valve of the hydraulic source of the attachment hydraulic circuit 62, opening a bypass valve, or preventing the spools of a flow control valve from moving.

(Step S8)

If it is determined in Step S5 that the specified period of time has elapsed, it is assumed that the attachment is a bucket.

(Step S9)

The display on the monitor is returned to the default screen. To be more specific, in cases where the bucket is replaced with another bucket 19, which does not require an attachment hydraulic circuit 62, it is troublesome to perform operation for selecting an attachment on the screen. Therefore, after the specified period of time has elapsed, the display on the monitor 52 for selecting an attachment is returned to the default screen. As the bucket does not require the attachment hydraulic circuit 62, the process proceeds to Step S7.

(Step S10)

If it is determined in Step S1 that the switch 53 for operating the quick coupler 18 to perform an attaching and detaching operation is at the unlocking position, the current attachment that has been selected is cleared.

(Step S11)

Warning is provided by a buzzer or other appropriate means to indicate that the attachment has been detached.

Next, the operations and effects of the embodiment illustrated in the drawings are explained hereunder.

Attachments are changed by means of the quick coupler 18, which is attached to the distal end of the arm 24.

At that time, removal and attachment of an attachment is performed by operating the switch 53 provided in the cab 14. In conjunction with this operation, available attachments are displayed on the monitor 52 in the cab 14 as illustrated in FIG. 1, and a prompt is given on the monitor 52 to select an attachment.

At that time, upon the operator selecting an attachment by means of the monitor 52, the attachment hydraulic circuit is adjusted to the flow rate and the pressure corresponding to those of the attachment that is going to replace the current attachment through the controller 61, which is connected to the monitor 52.

In other words, in accordance with the hydraulic attachment, which may be selected from among a hydraulic operated breaker 55, a hydraulic operated crusher 56, and a hydraulic operated grappler 57 etc., the set conditions, such as the pressure and the flow rate, of the hydraulic oil fed to the hydraulic attachment is automatically changed by controlling components of the attachment hydraulic circuit 62, such as pressure control valves (e.g. a relief valve, a pressure reducing valve, etc.) and flow control valves (e.g. a solenoid-operated directional control valve for controlling the pilot pressure of the main spool for the attachment), or the degree of priority over the other actuators is changed according to the hydraulic attachment.

As described above, in conjunction with operation of the switch 53 for operating the quick coupler 18 so that the quick coupler 18 performs attaching and detaching operation, a prompting screen for selecting, in other words designating, the mounted attachment from among a plurality of available attachments is displayed on the monitor 52 so that the attachment is selected by means of such a component of the monitor 52 as a touch panel, the button switches 58 assigned for the respective available attachments, or the aforementioned combination of the selection button unit and the “enter” button. Thus, selection can be made with a minimal operation, with essentially the same ease as with the conventional automatic selection systems without the need of providing each attachment with identification information. Furthermore, even with an operator who is operating a work machine 11 according to the present invention for the first time, a lapse or an operation mistake is prevented.

In accordance with the hydraulic attachment that has been selected by means of the monitor 52, the controller 61 automatically switches hydraulic settings for the attachment hydraulic circuit 62 based on conditions set for the respective attachments beforehand. Therefore, a hydraulic pressure and flow rate for the attachment hydraulic circuit 62 appropriate for each respective hydraulic attachment can reliably be supplied at an appropriate timing.

Until selection of an attachment is completed, the controller 61 retains the display for urging selection while restraining the functioning of the attachment hydraulic circuit 62 by withholding the supply of hydraulic oil to the attachment hydraulic circuit 62 or limiting the pressure or flow rate of the supplied hydraulic oil to an extremely low level. Therefore, even if the operator starts operation without remembering to perform selecting operation, not only is it possible to prevent damage to the hydraulic attachment but also promptly alert the operator to the irregularity, thereby reminding the operator to perform selection.

Moreover, the present invention is capable of achieving these effects without requiring additional parts or components.

Furthermore, until selection is made, the controller 61 continues to cause a notification signal in the form of a buzzer or voice guidance to be output in order to urge the making of a selection. By thus preventing the operator from a lapse in carrying out selection operation, selection of an attachment is ensured. With regard to system design of the quick coupler 18, in cases where warning of the unlocked state of an attachment is given in the form of buzzer, it is functionally desirable to give a notification signal in the form of voice guidance so as to prevent any confusion between the two types of warning.

As described above, even if the work machine 11 is provided with a hydraulic quick coupler 18, the present invention is capable of fully solving the problems with the work machines 11 that are not provided with an automatic identification device as well as problems with conventional automatic identification devices.

The present invention is applicable to a work machine 11, such as a hydraulic excavator, that is capable of selectively performing work by means of a plurality of attachments.

1. A work machine control device comprising:
a switch operating an attachment attaching and detaching device mounted on a work arm and serves to attach or detach a fluid pressure operated attachment;
a monitor displaying a prompting screen selecting an attachment in conjunction with operation of the switch operating the attachment attaching and detaching device; and
a controller switching, in accordance with the attachment selected by using the monitor, settings for an attachment fluid pressure circuit that serves to operate the attachment.

2. A work machine control device as claimed in claim 1, wherein:
the controller is capable of restraining functioning of the attachment fluid pressure circuit until selection of an attachment is made.

3. A work machine control device as claimed in claim 1, wherein:
the controller is capable of causing a notification signal to be output to urge selection of an attachment until selection of an attachment is made.
